(19) United States
(12) Patent Application Publication
(10) Pub. No.: US 2021/0115909 A1
(43) Pub. Date: Apr. 22, 2021

(54) SWASH PLATE-TYPE AXIAL PISTON PUMP

(71) Applicant: HYDAC DRIVE CENTER GMBH, Langenau (DE)

(72) Inventor: Manuel KRONPASS, Tittling (DE)

(21) Appl. No.: 17/047,773

(22) PCT Filed: Mar. 29, 2019
(86) PCT No.: PCT/EP2019/057982

§ 371 Date: Oct. 15, 2020

(30) Foreign Application Priority Data
Apr. 19, 2018 (DE) 10 2018 003 207.9

(51) Int. Cl. F04B 1/324; F04B 53/14; F04B 53/18

(52) U.S. Cl. CPC F04B 1/324; F04B 53/18; F04B 53/14

(57) ABSTRACT

1. Swash plate-type axial piston pump.
2. A swash plate-type axial piston pump, in particular for hydraulic systems, having a cylinder drum (3), which can be driven in rotation about an axis of rotation (7) in a pump housing (1) and in which pistons (9) are arranged axially movable, the actuating ends of which are accessible from outside of the cylinder drum (3) and are supported at least indirectly on a swash plate (15), which, in order to set the stroke of the pistons (9) and thus the fluid system pressure generated by these, can be swiveled to the desired angle of inclination relative to the axis of rotation (7) by means of an adjustment device (21), which has at least one swiveling lever (23), which can be deflected and returned in at least one direction by means of an actuator and which has in at least one hydraulically actuated actuating cylinder (31, 43) one actuating piston (35) each, which acts on one end on an articulation point (29) of the swivel lever (23), is characterized in that the at least one actuating piston (35, 47) has at its end, facing away from the articulation point (29), a guide surface (73), which is an integral part of the actuating piston (35, 47) and is in contact with an assigned guide surface (33, 45) of the actuating cylinder (31, 43) and in that at least one compensation means (75, 70, 59) is present, which orients the guide surfaces (73; 33, 45) in their respective positions relative to each other.
3. FIG. 5.

The invention relates to a swash plate-type axial piston pump, in particular for hydraulic systems, having a cylinder drum, which can be driven in rotation about an axis of rotation in a pump housing and in which pistons are arranged axially movable, the actuating ends of which are accessible from outside of the cylinder drum and are supported at least indirectly on a swash plate, which, in order to set the stroke of the pistons and thus the fluid system pressure generated by these, can be swiveled to the desired angle of inclination relative to the axis of rotation by means of an adjustment device, which has at least one swivel lever, which can be deflected and returned in at least one direction by means of an actuator and which has in at least one hydraulically actuated actuating cylinder one actuating piston each, which acts on one end on an articulation point of the swivel lever.

Swash plate-type axial piston pumps are state of the art. They are widely used for pressure media supply of loads such as working cylinders, hydraulic motors and the like. Axial piston pumps of the genus mentioned above, in which the inclination of a swash plate can be adjusted relative to the axis of rotation, are characterized by a better energy balance in operation in contrary to also known axial piston pumps having a fixed swash plate. Whereas pumps having a fixed swash plate as fixed displacement pumps at a predefined drive speed always deliver a constant volume flow of fluid, even if no energy is requested from pressure-medium actuated units and therefore at no-load the flow resistances in the hydraulic circuit have to be overcome, for which purpose drive energy is spent, which does not deliver any useful energy, by the adjustability of the inclination of the swash plate the delivery volume can be set to zero and the demand for drive energy can be minimized. An axial piston pump of the type mentioned above is disclosed in the document WO 2014/187512 A1.

The production of the known axial piston pumps of this genus is expensive, because a considerable constructional effort is required for the adjustment device having the gearing connection, which converts the linear motion of the respective actuating piston of the at least one fixed actuating cylinder into a swivel motion of the swash plate.

In view of this problem, the invention addresses the object of providing an axial piston pump whose adjustment device for setting the position of the swash plate is characterized by a high degree of operational reliability at a comparatively simple structure.

According to the invention, this object is achieved by an axial piston pump having the features of claim 1 in its entirety.

According to the characterizing part of claim 1, an essential feature of the invention is that at least one actuating piston has at its end, facing away from the articulation point, a guide surface, which is an integral part of the actuating piston and is in contact with an assigned guide surface of the actuating cylinder, and that at least one compensation means is provided, which orients the guide surfaces in their respective position relative to each other. The actuator can be implemented having only one single articulation point between the swivel lever and the actuating piston, because of the compensating device, provided according to the invention, which effects a mutual positional alignment of piston-sided guide surfaces and cylinder-sided guide surfaces. In the mentioned known solution a ball joint is formed between the piston and the piston rod of the actuating piston to keep the piston of the actuating cylinder free from constraining forces during adjustment movements, during which the swivel lever performs a swivel motion transverse to the cylinder axis of the actuating cylinder. Owing to the presence of the compensation means, this ball joint is omitted in the invention, so that the actuating piston and its piston rod can be integrally formed as a turned part. In addition to the resulting simplification and reduction in production costs, the elimination of the ball joint in the piston also reduces the friction forces and the hysteresis.

The compensation means can be formed at least partially by a spherical outer contour of at least one of the guide surfaces and/or a resiliently flexible sealing arrangement at the free end of at least one respective actuating piston and/or a compression spring arrangement and/or a lubricant supply.

In particularly advantageous embodiments, two actuating pistons are provided, both of which have at least one of the compensation means.

With particular advantage, the arrangement can be such that the free end face of one actuating piston is connected to a system pressure side and the free end face of the other actuating piston is connected to a control pressure side, which are part of the actuating device for the adjustment device.

The lubricant supply can have a longitudinal channel through one of the actuating pistons, which is preferably assigned to the system pressure side, and a further channel in the articulation point of the swivel lever. Advantageously a throttle on the free end face of the actuating piston can form the inlet of the longitudinal channel.

For particularly advantageous embodiments, the respective actuating piston has, adjacent to its end face, a sealing zone, formed by at least one piston ring, and a guide zone adjoining thereto, which forms the one spherical guide surface, which, by resting against the guide surface of the actuating cylinder, forms the compensation means, wherein a section of reduced diameter, forming the transition to the piston rod of the actuating piston, adjoins the guide zone.

In advantageous embodiments, the articulation point is formed by a ball joint having a ball head formed at the free end of the swivel lever and a ball socket formed on the respective actuating piston, wherein the spring arrangement holds the ball head and the respective ball socket in force-fitted contact with each other. This allows the entire actuator to be formed free of play.

The arrangement can advantageously be made such that the spring arrangement simultaneously pre-loads the swash plate in the swivel position corresponding to maximum pump delivery. Due to this double function of the spring arrangement, the actuating cylinder does not have to be formed as a double-acting cylinder for the generation of actuating movements in both directions, but a single-acting actuating cylinder may be provided, which only causes an actuating motion from the swivel position for maximum pump delivery to a lower delivery volume, down to zero delivery.

In particularly advantageous embodiments, the second actuating cylinder has a joint cylinder axis perpendicular to the axis of rotation and is arranged opposite from the first actuating cylinder, wherein the actuating piston of the second actuating cylinder can be hydraulically moved in contrary to the motion of the piston of the first actuating cylinder, wherein a second compensation means is formed between the second actuating cylinder and its piston rod by a guide zone, forming a spherical guide surface, of the piston of the second actuating cylinder and wherein the end of the piston rod of the second actuating cylinder forms a second ball joint at the actuating part of the swash plate.

In a particularly advantageous manner, the spring arrangement may have a compression spring, which preloads the piston rod of the second actuating piston for the motion, corresponding to the extension of the actuating piston of the second actuating cylinder and the retraction of the actuating piston of the first actuating cylinder and thus to the swiveling of the swiveling lever from the direction parallel to the axis towards the position of maximum pump delivery.

With regard to the actuation of the adjustment device, the arrangement may be advantageously such that the first actuating cylinder is pressurized with a control pressure for adjusting the pump delivery and the second actuating cylinder is pressurized with the existing system pressure. In this way the adjustment device is set to maximum delivery by the force of the compression spring, when there is no system pressure, i.e. when the pump is at a standstill.

When operating the pump with the resulting system pressure, the setting to maximum delivery is maintained until the actuating force, generated by the control pressure in the first actuating cylinder, exceeds the piston force, generated by the system pressure in the second actuating cylinder plus the spring force, after which, depending on the control pressure, the swash plate is swiveled back to a lower delivery rate.

For an operation at a control pressure of limited pressure level, preferably the piston surface, which can be pressurized by the control pressure, of the piston of the first actuating cylinder is selected to be larger than the piston surface, which can be pressurized by the system pressure, of the piston of the second actuating cylinder.

The invention is explained in detail below, with reference to an embodiment shown in the drawing. In the Figures:

FIG. 1 shows a longitudinal section of a swash-plate type axial piston pump according to the state of the art;

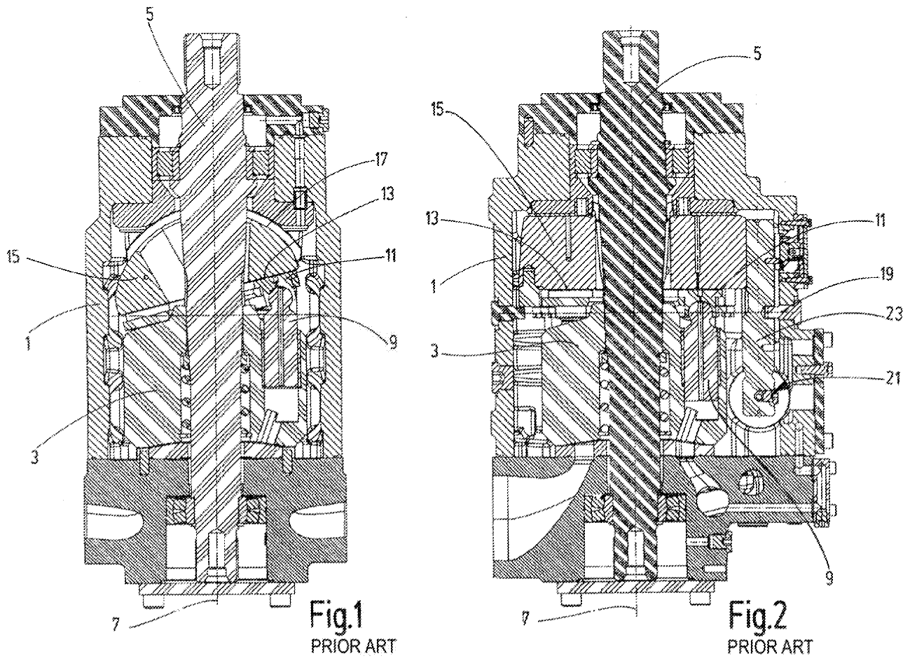

FIG. 2 shows a longitudinal section of the axial piston pump, rotated by 90° in relation to FIG. 1, in accordance with the state of the art;

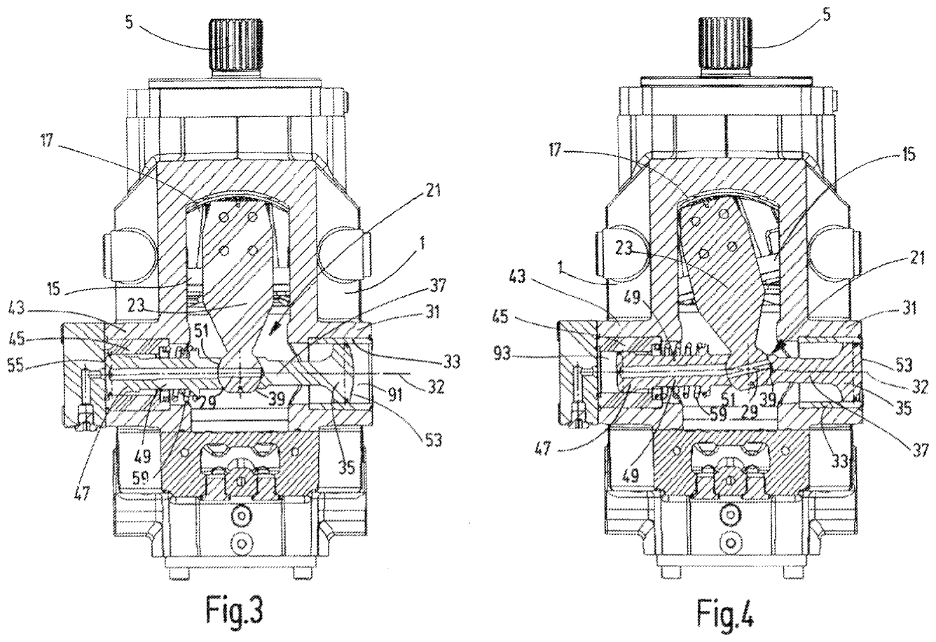

FIG. 3 shows a side view of the embodiment of the axial piston pump according to the invention, wherein the adjustment device is shown in sectional view;

FIG. 4 shows a representation corresponding to FIG. 3, wherein the adjustment device is shown in the operating state corresponding to maximum pump delivery;

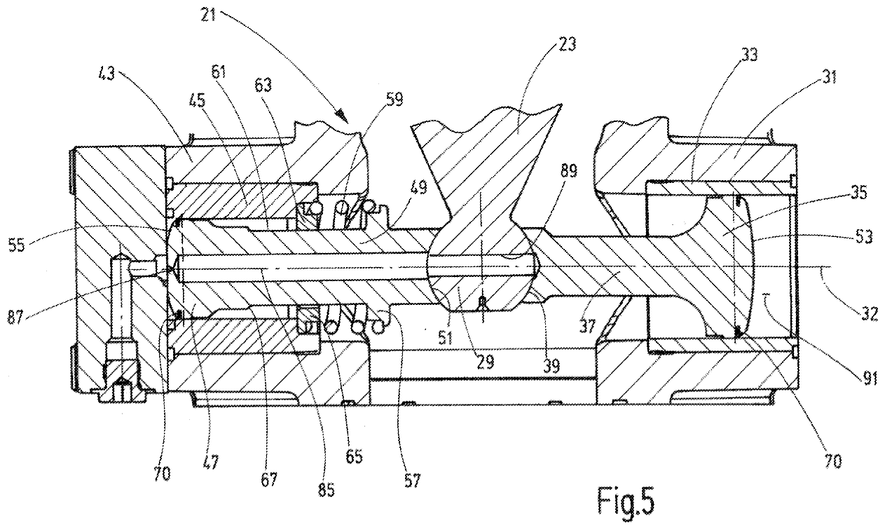

FIG. 5 shows a cut off representation enlarged in relation to FIGS. 3 and 4, wherein the adjustment device is shown in the operating state corresponding to zero delivery;

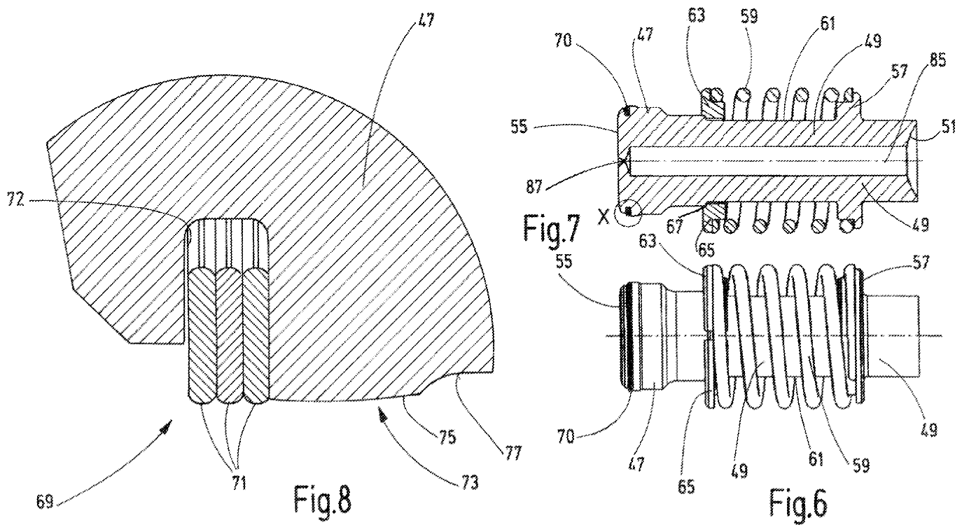

FIG. 6 shows a separate representation of the actuating piston, left-sided in FIG. 5, of the embodiment according to the invention;

FIG. 7 shows a longitudinal section of the representation of FIG. 6;

FIG. 8 shows the area marked X in FIG. 7 in a representation enlarged about 50 times compared to FIG. 7;

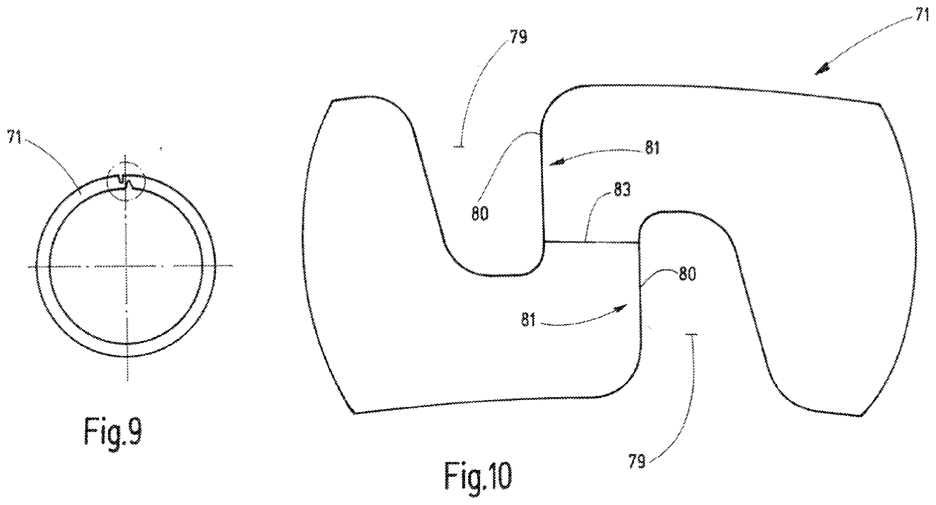

FIG. 9 shows a side view of a piston ring of the embodiment, having a separation point; and

FIG. 10 shows the area, designated by Y in FIG. 9, of the separation point in a representation enlarged about 50 times compared to FIG. 9.

In the figures, of which FIGS. 1 and 2 show an axial piston pump in accordance with the state of the art and FIGS. 3 to 10 show an embodiment of the invention, a pump housing is designated by 1, in which a cylinder drum 3 can be rotated about an axis of rotation 7 by means of a drive shaft 5. As can best be seen in FIGS. 1 and 2, which show a state-of-the-art axial piston pump, axially movable pistons 9, located in the cylinder drum 3, are supported on the sliding surface 13 of a swash plate 15 by sliding shoes 11 located at the upper ends of the pistons 9. At the end, facing away from the sliding surface 13, the swash plate 15 is movably guided on the pump housing 1 via an circular arc-shaped swash-plate bearing 17 such that the swash plate 15 can be swiveled about a swivel axis, which, running perpendicular to the axis of rotation 7, runs in the plane of the sliding surface 13 of the swash plate 15 and thus perpendicular to the drawing plane of FIGS. 1, 3 and 4. By means of an adjustment device designated as a whole by 21, the swash plate 15 can be swiveled about this swivel axis between the swivel settings shown in FIGS. 1 and 4, which correspond to the maximum delivery rate of the pump, and the settings shown in FIGS. 2, 3 and 5 on zero delivery, wherein in this process the plane of the sliding surface 13, in relation to the vertical course of the axis of rotation 7, is in the horizontal, such that no stroke of the pistons 9 occurs during the rotation of the cylinder drum 3.

As the actuating part assigned to the swash plate 15, the adjustment device 21 has a swivel lever 23, which is attached to the swash plate 15 and extends laterally of the swash plate 15 and the cylinder drum 3. A swivel pin 19 (see FIG. 2) is used to swivel mount the swivel lever 23 on the housing 1. The swivel lever 23 has an articulation point 29 at its lower free end, at which the actuators of the adjustment device 21 act in order to move the swivel lever 23 in the drawing plane of FIGS. 1 and 3 to 5 and thus swivel the swash plate 15 about its swivel axis.

As shown in FIGS. 3 to 5, the adjustment device 21 has a first actuating cylinder 31 having a cylinder liner 33 defining a cylinder axis 32, wherein in said cylinder liner 33 an actuating piston 35 is guided. The piston 35 is formed by a turned part, integral with its piston rod 37, and has a ball socket 39 at its free end, which forms a ball joint by contacting the ball head 29, forming the articulation point, of the swivel lever 23. Opposite from the first actuating cylinder 31 and located on the same cylinder axis 32 therewith, the adjustment device 21 has a second actuating cylinder 43 having a cylinder liner 45. A second actuating piston 47 is guided therein, which, like the first actuating piston 35, together with its piston rod 49 is formed by a one-piece turned part. Like the first actuating piston 35, the second actuating piston 47 has a ball socket 51 at the free end of its piston rod 49, wherein said ball socket 51 forms a second ball joint by contacting the ball head 29 of the swivel lever 23. The pressurized piston area 53 of the first piston 35 is larger than the pressurized piston area 55 of the second actuating piston 47. A compression spring 59 is clamped between the cylinder liner 45 of the second actuating cylinder 43 and a spring plate 57, which is formed by a radially projecting collar of the piston rod 49 of the second actuating piston 47, wherein said compression spring 59 pretensions the adjustment device 21 to the setting shown in FIG. 4, corresponding to the maximum pump delivery, and also keeps the ball joints formed at the ball head 29 of the swivel lever 23 free of play.

To keep the actuating pistons 35 and 37 free from constraining forces during the adjustment movements, in which the ball head 29 of the swivel lever 23 moves slightly away from the cylinder axis 32 at a vertical motion component, the invention provides a compensation means, which replaces the additional ball joint provided for this purpose in the state of the art and arranged in the respective actuating piston. In the present embodiment of the invention, the compensation means is formed by guide surfaces on the respective actuating piston 35, 47, which is integrally formed with its piston rod 37 or 49, and formed by a guide surface on the associated actuating cylinder 31, 43, more precisely, by its cylinder liner 33 or 45. In the embodiment shown, a special outer contour of the respective actuating piston 35, 47 is provided as a guide surface forming part of the compensation means. The corresponding design is explained with reference to FIGS. 6 to 8, which contain separate representations of the second actuating piston 47 that is integral with its piston rod 49. The circumferential profile shown in these figures, and in particular in FIG. 8, for the smaller actuating piston 47 corresponds fully to the circumferential profile of the larger actuating piston 35.

FIGS. 6 and 7 show the actuating piston 47 having the pressure spring 59 premounted thereon, which rests on one side on the fixed spring plate 57 of the piston rod 49 and rests at the other end on a spring plate, which can be moved on the circular cylindrical outer surface 61 of the piston rod 49, which is a spring plate composed of two ring halves 63 and 65. In the relaxed state of the compression spring 59, shown in FIGS. 6 and 7, the split spring plate 63, 65 is in contact with a step 67 of the piston rod 49. The design of the outer contour of the actuating pistons 35 and 47, which as part of the compensation means permits a limited deflection motion of the axis of the piston rods 37, 49 from the cylinder axis 32, is only shown in more detail for the smaller piston 47 in FIG. 8 by way of example. As shown, near the front piston surface 55, a sealing zone 69 is formed by a piston ring pack 70, which consists of three equally formed piston rings 71, one of which is shown in FIGS. 9 and 10 in more detail. On the end facing away from the piston surface 55 a guide zone 73 adjoins to the piston rings 71 (see FIG. 8). The guide zone 73 is formed by a circumferential section 75, which forms the respective piston-sided guide surface and has a slight spherical curvature, which is selected such that the piston 47, even for a slight axial deviation, is guided in the respective cylinder liner 33, 45, which form the cylinder-sided guide surface. Section 77, having a reduced outer circumference, in turn adjoins the section 75 (FIG. 8), wherein said section 77 forms the transition to the circumferential sections, having a further reduced outer diameter, of the piston rod 49.

FIGS. 9 and 10 show the construction of the piston rings 71. In FIG. 10 the open area, marked Yin FIG. 9, of the respective piston ring 71 is shown in more detail. As shown, this area is toothed in such a way that the piston ring 71 is elastically flexible, because there are free spaces 79 at the transition area of its ring ends 80, within the free spaces 79 the two ring ends 80 can move against each other, as indicated by direction arrows 81, while sliding against each other at a separation point 83, which forms a sealing surface. For the lubricant supply of the ball joints formed from the ball head 29 and the ball sockets 39 and 51, a drilled hole 85 for lubricants is formed in the piston 47, which can be subjected to the system pressure, and continuous in the piston rod 49, wherein said drilled hole 85, starting from a throttle point 87 located on the piston surface 55, leads to the ball socket 51 and from there continues via a drilled hole 89 in the ball head 29 to the ball socket 39 of the larger piston 35.

As mentioned, the pressure chamber 91 of the actuating cylinder 31 (FIGS. 3 and 5) can be pressurized with the control pressure actuating the adjustment device 21, while the pressure chamber 93 of the actuating cylinder 43 (FIG. 4) can be pressurized with the system pressure. FIG. 4 shows the setting to maximum delivery rate and no control pressure in pressure chamber 91 of the larger actuating piston 35. Due to the system pressure acting in the pressure chamber 93 of the smaller actuating piston 47 and the force of the compression spring 59, which rests on the cylinder liner 45 via the split spring plate 63, 65, the pistons 35 and 47 are shifted to the right in the drawing and the swivel lever 23 is swiveled out into the position shown in FIG. 4. To set the adjustment device 21 to a lower delivery rate, an appropriate control pressure is supplied to the pressure chamber 91 of the actuating cylinder 31. As soon as this exceeds the combined force resulting from the system pressure in the pressure chamber 93 of the smaller piston 47 and from the force of the compression spring 59, the pistons 35, 47 move to the left in the drawing, wherein the delivery rate can be reduced to zero delivery, as shown in FIGS. 3 and 5, wherein the split spring plate 63, 65 has shifted on the cylindrical section 61 of the piston rod 49 and moved away from the step 67, wherein the compression spring 59 is compressed. Due to the action of the compression spring 59 the adjustment device is set to the maximum delivery rate, shown in FIG. 4, even when the pump is at a standstill and thus there is no system pressure.

1. A swash plate-type axial piston pump, in particular for hydraulic systems, having a cylinder drum (3), which can be driven in rotation about an axis of rotation (7) in a pump housing (1) and in which pistons (9) are arranged axially movable, the actuating ends of which are accessible from outside of the cylinder drum (3) and are supported at least indirectly on a swash plate (15), which, in order to set the stroke of the pistons (9) and thus the fluid system pressure generated by these, can be swiveled to the desired angle of inclination relative to the axis of rotation (7) by means of an adjustment device (21), which has at least one swiveling lever (23), which can be deflected and returned in at least one direction by means of an actuator and which has in at least one hydraulically actuated actuating cylinder (31, 43) one actuating piston (35) each, which acts on one end on an articulation point (29) of the swivel lever (23), characterized in that the at least one actuating piston (35, 47) has at its end, facing away from the articulation point (29), a guide surface (73), which is an integral part of the actuating piston (35, 47) and is in contact with an assigned guide surface (33, 45) of the actuating cylinder (31, 43), and in that at least one compensation means (75, 70, 59) is present, which orients the guide surfaces (73; 33, 45) in their respective position relative to each other.

2. The axial piston pump according to claim 1, characterized in that the compensation means is formed at least partly by
a spherical outer contour (75) of at least one of the guide surfaces (73) and/or
a resiliently flexible sealing arrangement (70) at the free end of at least one respective actuating piston (35, 47) and/or
a compression spring arrangement (59) and/or
a lubricant supply (85, 87, 89).

3. The axial piston pump according to claim 1, characterized in that two actuating pistons (35, 47) are provided, both of which have at least one of the compensation means.

4. The axial piston pump according to claim 1, characterized in that the free end face (55) of one actuating piston (47) is connected to a system pressure side and the free end face (53) of the other actuating piston (35) is connected to a control pressure side, which are part of the actuating device for the adjustment device (21).

5. The axial piston pump according to claim 1, characterized in that the lubricant supply has a longitudinal channel (85) through one of the actuating pistons (47), which is preferably assigned to the system pressure side, and a further channel (89) in the articulation point (29) of the swivel lever (23).

6. The axial piston pump according to claim 1, characterized in that the respective actuating piston (35, 47) has, adjacent to its end face (53, 55), a sealing zone (69), formed by at least one piston ring (71), and a guide zone (73) adjoining thereto, which forms the one spherical guide surface (75), which, by resting against the guide surface (33, 45) of the actuating cylinder (31, 43), forms the compensation means, and in that a section (77) of reduced diameter, forming the transition to the piston rod (37, 49) of the actuating piston (35, 47), adjoins the guide zone (73).

7. The axial piston pump according to claim 1, characterized in that the articulation point is formed by a ball joint having a ball head (29), formed at the free end of the swivel lever (23), and a ball socket (39, 51) formed on the respective actuating piston (35, 47), and in that the spring arrangement (59) holds the ball head (29) and the respective ball socket (39, 51) in force-fitted contact with each other.

8. The axial piston pump according to claim 1, characterized in that the spring arrangement (59) pre-loads the swash plate (15) in the swivel position corresponding to maximum pump delivery.

9. The axial piston pump according to claim 1, characterized in that the swivel lever (23) extends laterally of the swash plate (15) and of the cylinder drum (3) in parallel to the axis of rotation (7) when set to zero pump delivery and has the ball joint (29, 39, 51) at its free end.

10. The axial piston pump according to claim 1, characterized in that the second actuating cylinder (43) has a joint cylinder axis (32) perpendicular to the axis of rotation (7) and is arranged opposite from the first actuating cylinder (31), in that the actuating piston (47) of the second actuating cylinder (43) can be hydraulically moved in contrary to the motion of the piston (35) of the first actuating cylinder (31), in that a second compensation means is formed between the second actuating cylinder (43) and its piston rod (49) by a guide zone (73), forming a spherical guide surface (75), of the piston (47) of the second actuating cylinder (43) and in that the end of the piston rod (49) of the second actuating cylinder (43) forms a second ball joint (29, 51) at the actuating part (23) of the swash plate (15).

11. The axial piston pump according to claim 1, characterized in that the spring arrangement has a compression spring (59), which preloads the piston rod (49) of the second actuating piston (47) for the motion, corresponding to the extension of the actuating piston (47) of the second actuating cylinder (43) and the retraction of the actuating piston (35) of the first actuating cylinder (31) and thus to the swiveling of the swivel lever (23) from the direction parallel to the axis towards the position of maximum pump delivery.

12. The axial piston pump according to claim 1, characterized in that the face surface (53), which can be pressurized by the control pressure, of the piston (35) of the first actuating cylinder (31) is selected to be larger than the piston area (55), which can be pressurized by the system pressure, of the piston (47) of the second actuating cylinder (43).

13. The axial piston pump according to claim 1, characterized in that the respective actuating piston (35, 47), adjacent to its end face (53, 55), has a sealing zone, formed by at least one piston ring (71), wherein said sealing zone (69) is formed by a piston ring pack (70) consisting of at least two, preferably three, equally formed piston rings (71).

14. The axial piston pump according to claim 1, characterized in that the respective actuating piston (35, 47), adjacent to its end faces (53, 55), has a sealing zone (69), formed by at least one piston ring (71), which is formed elastically flexible due to the free spaces (79), formed at the transition area of its ring ends (80), wherein within said free spaces (79) the two ring ends (80) can move relative to one another.
